(19) United States
(12) Patent Application Publication
(10) Pub. No.: US 2008/0060464 A1
(43) Pub. Date: Mar. 13, 2008

(54) APPARATUS AND METHOD FOR DRIVING A DRIVEN UNIT OF A PRINTING PRESS

(75) Inventors: Alfons BAINTNER, Aystetten (DE); Norbert Dylla, Stadtbergen (DE); Max Eder, Mering (DE); Josef Hammer, Plauen (DE); Guenter Koppelkamm, Neuensalz (DE); Rainer Liebold, Neundorf (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/852,027

(22) Filed: Sep. 7, 2007

(30) Foreign Application Priority Data
Sep. 8, 2006 (DE) 10 2006 042 210.4

(51) Int. Cl. G05G 9/00; F16H 55/17

(52) U.S. Cl. 74/434; 74/471 R

(57) ABSTRACT

An apparatus and method for driving a driven unit of a printing press, specifically a printing couple or a folding unit of a rotary web press, is disclosed. A cylinder or roller to be driven is driven by a drive with an interposed transmission. An input element is mounted on a shaft of the cylinder or the roller to be driven and an output element is assigned to the drive co-acting with the input element. A shaft of the drive is carried in at least two bearing locations. The output element is mounted directly to the shaft of the drive such that the output element is located immediately adjacent a bearing location of the shaft of the drive.

This application claims the priority of German Patent Document No. 10 2006 042 210.4, filed Sep. 8, 2006, the disclosure of which is expressly incorporated by reference herein.

### BACKGROUND AND SUMMARY OF THE INVENTION

The invention relates to an apparatus and method for driving a driven unit of a printing press.

Printing presses, for example web rotary presses, have a plurality of driven units, for example printing couples, folding units, inking couples and dampening units. Normally, one drive is assigned to the driven units of a printing press, wherein the drive drives a cylinder or a roller of the unit to be driven through an interposed transmission. The term transmission should be understood to include all possible types of transmissions with the aid of which speed or torque can be transmitted, as for example gear drives, toothed belt drives, chain drives or even friction drives.

In the case of driven units for a printing press known from practice, the transmission comprises an input element assigned to the cylinder to be driven or the roller to be driven and an output element assigned to the drive. The input element is, according to previous practice, mounted directly on a shaft of the cylinder or roller to be driven, the output element assigned to the drive on the other hand, according to previous practice, is mounted on a separate shaft which is in a driveable mechanical connection by way of a clutch, preferably an alignment compensating clutch, with the shaft of the drive. Both the shaft of the drive, as well as the shaft on which the output element is mounted, have at least two bearing locations. This principle known from practice for coupling the drive to a cylinder or shaft to be driven of a driven unit for a printing press is relatively complicated in design as well with respect to assembly.

There exists accordingly a need for driven units for printing presses, the construction of which is simpler in design to provide cost benefits and simpler assembly for the driven unit.

With this as the point of departure, the problem underlying the present invention is to create a new type of driven unit for a printing press. In accordance with the invention, the output element is mounted directly on the shaft of the drive such that the output element is located directly or immediately adjacent a bearing location of the shaft of the drive.

In the meaning of the present invention, the output element of the transmission is mounted directly to or on the shaft of the drive, and specifically such that the output element is located directly adjacent a bearing location of the shaft of the drive. As a result of the output element being mounted directly or immediately on the shaft of the drive, there is no need on the one hand for the separate shaft required from previous practice to carry the output element or on the other hand for the alignment compensation clutch. Furthermore, the number of bearing locations can be reduced. The driven unit in accordance with the invention for a printing press is of a simpler design construction and is therefore less expensive and easier to assemble than driven units known from practice. Furthermore, the result is greater overall stiffness for the driven unit in accordance with the invention, which is advantageous in particular with respect to regulating or controlling the driven unit.

Preferred further developments of the invention become clear from the subsequent description. Embodiments of the invention, without being restricted thereto, are explained in more detail using the drawing.

### BRIEF DESCRIPTION OF THE DRAWINGS

FIG. 1 shows a schematic view of an embodiment of a driven unit for a printing press in accordance with the invention.

### DETAILED DESCRIPTION OF THE DRAWINGS

The present invention relates to a driven unit for a printing press which includes a drive which drives a cylinder or a roller to be driven through an interposed transmission. In what follows the point of departure is that the driven unit for a printing press in accordance with the invention is a printing couple for a web rotary press and that the transmission is designed as a gear drive. It should be pointed out at this juncture that the invention is not restricted to this preferred application. To the contrary, the invention can be used with all driven units for a printing press, such as a folding unit, inking couple and dampening unit. Furthermore, the transmission does not have to be executed as a gear drive, rather the transmission can also be executed as a toothed belt drive, chain drive or friction wheel drive.

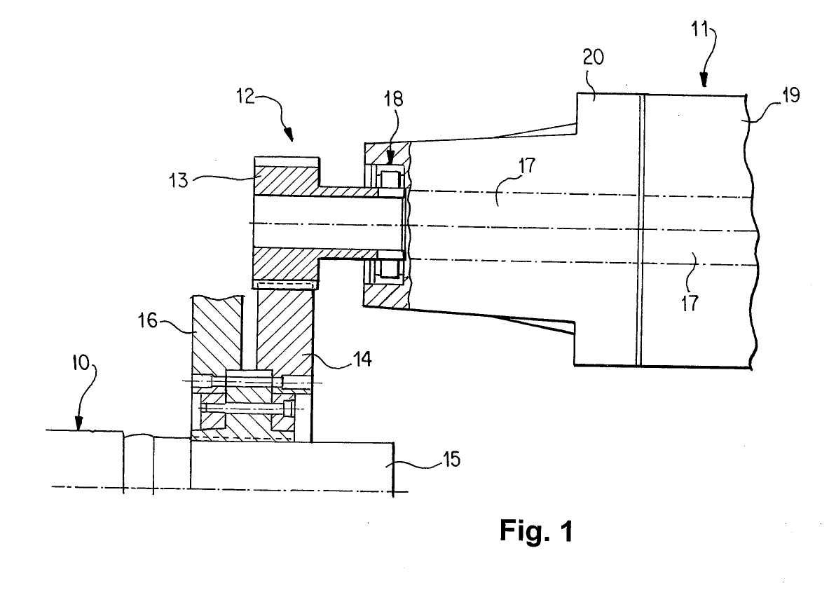

FIG. 1 shows a section from a driven unit for a printing press configured as a printing couple in the area of a transfer cylinder or a rubber cylinder 10 of the printing couple to be driven. The rubber cylinder 10 to be driven is driven by a drive 11 with an interposed transmission 12, where the transmission 12 in accordance with FIG. 1 includes an output element 13 assigned to the drive 11 and an input element 14 assigned to the rubber cylinder 10 to be driven. Output element 13 and input element 14 of the transmission 12 are executed as gear wheels which are in direct engagement.

The input element 14 assigned to the rubber cylinder 10 to be driven is mounted on a shaft 15 of the rubber cylinder 10, where in accordance with FIG. 1 an additional transmission element 16 configured as a gear is mounted on the shaft 15 in addition to the input element 14 by way of which the driven rubber cylinder 10 drives a form cylinder or plate cylinder—not shown—of the printing couple.

In accordance with the invention, the output element 13 of the transmission 12 is mounted directly or immediately adjacent to, or on, a shaft 17 of the drive 11. The output element 13 accordingly engages the shaft 17 of the drive 11 without a clutch, therefore clutchlessly.

In accordance with FIG. 1, the output element 13 of the transmission 12 is located immediately adjacent a bearing location 18 for the shaft 17 of the drive 11, the effect of which is that any potential skewing of the output element 13 as a consequence of flexing of the shaft 17 of the drive 11 is as small as possible and the service life of the bearing location 18 is as long as possible.

In the simplest instance of the invention, the shaft of the drive is mounted at only two bearing locations, wherein the output element is located immediately adjacent one of the two bearing locations.

In contrast, FIG. 1 shows a variation in which the shaft 17 of the drive 11, as a result of the installation conditions in the printing couple, is extended and carried by way of an auxiliary bearing location in the area of bearing location 18, in addition to primary bearing locations not shown. The output element 13 of the transmission 12 is located immediately adjacent the auxiliary bearing location 18. In the embodiment shown, the shaft 17 of the drive 11 is accordingly mounted at three bearing locations, specifically at two primary bearing locations, which are not shown, and the auxiliary bearing location 18.

In the embodiment shown, the drive 11 has a housing 19 which contains the primary bearing locations which are not shown. The auxiliary bearing location 18 is contained in an auxiliary housing 20 which is assembled to or centered to the housing 19 of the drive 11.

In contrast, it is also possible to assign the auxiliary bearing locations directly to the housing of the drive.

In the meaning of the present invention, the output element 13 of the transmission 12 by way of which the drive 11 engages the rubber cylinder 10 of the printing couple to be driven, can accordingly be mounted or connected immediately or directly on the shaft 17 of the drive 11 without interposition of a clutch. The output element 13 is located in the immediate vicinity of a bearing location 18 of the shaft 17 of the drive 11. In the case of this bearing location, it is either a primary bearing location or an auxiliary bearing location for the shaft 17 of the drive 11.

### REFERENCE NUMERAL LIST

10 Rubber cylinder
11 Drive
12 Transmission
13 Output element
14 Input element
15 Shaft
16 Transmission element
17 Shaft
18 Bearing location
19 Housing
20 Auxiliary housing

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A driven unit of a printing press, specifically a printing couple or folding unit for a rotary web press, having a cylinder or roller to be driven by a drive with an interposed transmission, wherein the transmission has an input element mounted on a shaft of the cylinder or roller to be driven and an output element assigned to the drive and co-acting with the input element, wherein a shaft of the drive is mounted in at least two bearing locations, and wherein the output element is mounted directly to, or on, the shaft of the drive such that the output element is located immediately adjacent a bearing location of the shaft of the drive.

2. The unit according to claim 1, wherein the shaft of the drive is mounted at only two bearing locations and the output element is located immediately adjacent one of the two bearing locations.

3. The unit according to claim 1, wherein the shaft of the drive is mounted at two primary bearing locations and a lateral auxiliary bearing location and the output element is located immediately adjacent the auxiliary bearing location.

4. The unit according to claim 3, wherein the auxiliary bearing location is assigned to an auxiliary housing, wherein the auxiliary housing is centered to a housing of the drive.

5. The unit according to claim 3, wherein the auxiliary bearing location is assigned to a housing of the drive.

6. The unit according to claim 1, wherein the input element and the output element are configured as gears which are in direct engagement.

7. An apparatus for driving a driven unit of a printing press, comprising:
a drive including a shaft, wherein the shaft of the drive is mounted at a first bearing location and a second bearing location; and
a transmission coupled to the drive, wherein the transmission includes:
an output element coupled to the shaft of the drive, wherein the output element is located immediately adjacent to one of the first and second bearing locations; and
input element coupled to the output element and coupleable to a shaft of the driven unit.

8. The apparatus according to claim 7, wherein the output element is a first gear wheel and the input element is a second gear wheel.

9. The apparatus according to claim 7, wherein the output element is directly driven by the shaft of the drive.

10. The apparatus according to claim 7, wherein the output element is connected to the one of the first and second bearing locations.

11. The apparatus according to claim 7, wherein the output element is directly connected to the shaft of the drive.

12. A method for driving a driven unit of a printing press, comprising the steps of:
driving an output element of a transmission directly by a shaft of a drive, wherein the shaft of the drive is mounted at a first bearing location and a second bearing location and wherein the output element is located immediately adjacent to one of the first and second bearing locations;
driving an input element of the transmission by the output element; and
driving the driven unit of the printing press by the input element of the transmission.
